(19) United States
(12) Patent Application Publication
(10) Pub. No.: US 2012/0228233 A1
(43) Pub. Date: Sep. 13, 2012

(54) APPARATUS AND METHOD FOR FLUID MIXING

(75) Inventors: Mitsuharu Terashima, Shinjuku-ku (JP); Hideaki Iino, Shinjuku-ku (JP)

(73) Assignee: KURITA WATER INDUSTRIES LTD., Tokyo (JP)

(21) Appl. No.: 13/395,804

(22) PCT Filed: Sep. 16, 2010
(86) PCT No.: PCT/JP2010/066016

§ 371 Date: May 17, 2012

(30) Foreign Application Priority Data
Sep. 18, 2009 (JP) 2009-217305
Mar. 31, 2010 (JP) 2010-080891

(51) Int. Cl. B01F 5/06; C02F 1/52

(52) U.S. Cl. 210/738; 366/150.1; 366/151.1

(57) ABSTRACT

There is provided an apparatus and method for fluid mixing, which enable mixing efficiency to be enhanced and enable a lodging impurity to be easily removed. A liquid, powder, or the like is added from a pipe 2 to a liquid flowing in a pipe 1, and the resultant liquid then passes a plurality of half-open ball valves 3A to 3C, thereby being mixed. The ball valves 3A to 3C each have angular difference θ in the position around the axis thereof. Sufficient mixing can be performed without preparing a static mixer having a complicated structure. In addition, in the case where clogging due to an impurity occurs, the valve is opened with the result that the impurity can be released.

### FIELD OF INVENTION

The present invention relates to an apparatus and method for fluid mixing, in which a liquid, gas, powder, or the like is allowed to flow into another liquid and is then mixed with the other liquid while flowing in a pipe.

### BACKGROUND ART

In the case where a liquid, powder, slurry, or the like is allowed to flow into another liquid (including addition) and is then mixed with the other liquid while flowing in a pipe, a static mixer (line mixer) has been widely used (see FIG. 2 in patent document 1).

Patent document 2 discloses a technique in which a pipe is bent to make water flow turbulent and in which pressurized water (gas-dissolved water) is then added with the result that water mixing efficiency of the pressurized water is enhanced.

### LIST OF DOCUMENTS

### Patent Documents

Patent document 1: Japanese Utility Model Publication 1-109700A

Patent document 2: Japanese Patent Publication 2007-136285A

### OBJECT AND SUMMARY OF INVENTION

### Object of Invention

In a static mixer, an element to form turbulence is disposed in a pipe. In the case where an impurity has becomes lodged in the pipe or clogs the pipe, the flow of water needs to be stopped, and the pipe also needs to be opened, in order to remove the impurity.

The technique disclosed in the patent document 2 in which fluids are mixed with each other using the bent pipe that serves to enhance turbulence exhibits poor mixing efficiency as compared with the case in which the fluids are mixed using a static mixer.

It is an object of the invention to provide an apparatus and method for fluid mixing, which provide high mixing efficiency and enable a lodging impurity to be easily removed.

### SUMMARY OF INVENTION

According to a first aspect of the invention, an apparatus for fluid mixing is provided, which includes a pipe in which a first fluid flows, a junction through which any one of a second fluid and powder flows into the pipe, and an openable and closable valve provided to a pipe downstream of the junction. The valve is in a half-open state.

According to a second aspect of the invention, the apparatus for fluid mixing of the first aspect has a pressure detector which detects a pressure inside the pipe upstream of the valve.

According to a third aspect of the invention, the apparatus for fluid mixing of the first aspect has a pressure loss detector which detects a pressure loss inside the pipe between the upstream and downstream sides relative to the valve.

According to a fourth aspect of the invention, in the apparatus for fluid mixing of any one of the first to third aspects, any one of a ball valve and butterfly valve is employed as the valve.

According to a fifth aspect of the invention, in the apparatus for fluid mixing of the fourth aspect, a plurality of the valves are provided in line, and the position around the axis of one valve differs from the position around the axis of the adjacent valve.

According to a sixth aspect of the invention, a method for fluid mixing is provided, the method including a process of mixing a fluid using the apparatus for fluid mixing of any one of the first to fifth aspects. In the case where an impurity becomes lodged in the valve, the opening degree of the valve is changed, and the impurity is then released.

According to a seventh aspect of the invention, in the method for fluid mixing of the sixth aspect, the apparatus for fluid mixing of the second aspect is used. A pressure inside the pipe is measured with the pressure detector in any one of continuous and constant manners, and the opening degree of the valve is changed in the case where the pressure increases and then reaches a certain level.

According to an eighth aspect of the invention, in the method for fluid mixing of the sixth aspect, the apparatus for fluid mixing of the third aspect is used. A pressure loss inside the pipe is measured with the pressure loss detector in any one of continuous and constant manners, and the opening degree of the valve is changed in the case where the pressure loss increases and then reaches a certain level.

### Advantageous Effects of Invention

In the apparatus and method of embodiments of the invention, one fluid flows into another fluid through the junction, and the fluids then pass the valve, which is in a half-open state, with the result that the turbulence of the fluids is enhanced. The fluids are therefore sufficiently mixed.

In the case where an impurity has adhered to the valve disc of the valve, the opening degree of the valve is changed, thereby removing the impurity.

The following mechanism is preferably provided: the pressure detector which detects a pressure inside the pipe upstream of the valve is provided, and the pressure inside the pipe is measured with the pressure detector in any one of continuous and constant manners; and in the case where the pressure increases and reaches a certain level, it is determined that an impurity has become lodged in the valve, and the opening degree of the valve is changed.

Alternatively, the following mechanism may be provided: the pressure loss detector which detects a pressure loss inside the pipe between the upstream and downstream sides relative to the valve are provided, and the pressure loss inside the pipe between the upstream and downstream sides relative to the valve is measured with the pressure loss detector in any one of continuous and constant manners; and in the case where the pressure loss increases and reaches a certain level, it is determined that an impurity has become lodged in the valve, and the opening degree of the valve is changed.

By virtue of such mechanisms, the following problems can be prevented: waste of energy due to the operation of the apparatus for fluid mixing in a state in which an impurity has become lodged inside the pipe and then increases a pressure inside the pipe; and a decreased flow rate caused by clogging of the pipe. Furthermore, the unnecessary changing of the opening degree of the valve can be prevented in the case where an impurity has not become lodged in the valve, and the apparatus for fluid mixing can be efficiently operated.

In terms of enhancement of turbulence in a fluid channel, a rotating-type fluid channel-blocking valve (butterfly valve or ball valve) is preferably employed as the valve. In the case where the valve is fully opened when the apparatus for fluid mixing is clogged with an impurity, the ball valve has a fluid-passing portion with a shape similar to that of the pipe, and the ball valve is therefore further preferably employed. In particular, a ball valve having a hole with a size approximately similar to the diameter of the pipe is preferably employed because such a ball valve can have a cross-sectional area substantially the same as the dimension of the diameter of the pipe, and a full-bore ball valve is most preferably employed. In this case, a gate-type fluid channel-blocking valve may be employed.

In the case of using the gate-type fluid channel-blocking valve, the difference in an angle between one valve and the subsequent valve is preferably 30° or larger, and more preferably 90° or larger. In the case of using two valves, the difference in angle is most preferably 120°, and angles of 180° and 90° are also preferable in order.

### BRIEF DESCRIPTION OF DRAWINGS

FIG. 1 is a cross-sectional view schematically illustrating a mixing apparatus of an embodiment of the invention.

FIG. 2 is a cross-sectional view partially illustrating a ball valve.

FIG. 3 is a cross-sectional view partially illustrating a butterfly valve.

FIG. 4 is a cross-sectional view schematically illustrating a mixing apparatus of another embodiment of the invention.

FIG. 5 is a cross-sectional view schematically illustrating a mixing apparatus of another embodiment of the invention.

### DESCRIPTION OF EMBODIMENTS

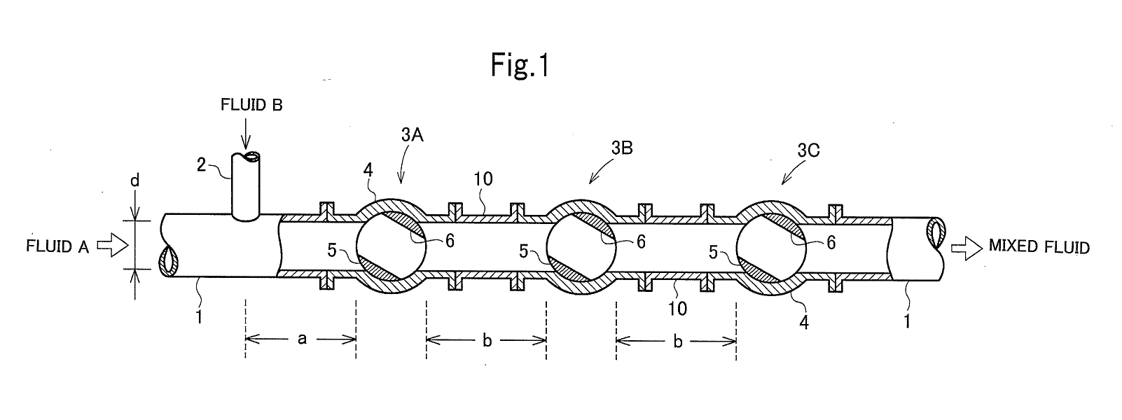

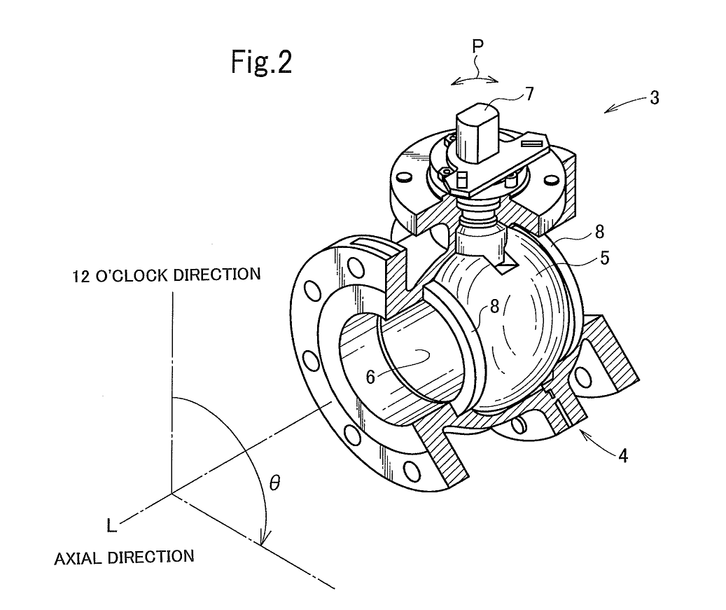

A first embodiment will be hereinafter described with reference to FIGS. 1 and 2.

In this embodiment, as illustrated in FIG. 1, a fluid B fed from a branch pipe 2 is added to a fluid A (liquid in this embodiment) which flows in a pipe (main pipe) 1. Examples of the fluid B include chemicals (for example, chemicals such as a coagulant, pH adjuster, anticorrosive, and antifungal agent), slurry, various types of liquids such as gas-dissolved water, and various types of gas such as air, nitrogen, oxygen, and carbon dioxide gas. In place of the fluid B, powder may be added.

A plurality of ball valves are connected to the pipe 1 and arranged in line in the downstream direction of the pipe 1. In this embodiment, although three ball valves 3A, 3B, and 3C are provided, the number of ball valves is not limited. However, the number of ball valves provided is preferably two or more, for example two to ten, and more preferably three to four.

Each of the ball valves 3A, 3B, and 3C has a structure in which a ball (valve disc) 5 is disposed inside a valve body 4, and the ball 5 has a through-hole 6 formed so as to penetrate the ball 5 in a diameter direction. The structure of the ball valves 3A, 3B, and 3C is not specifically limited, and various types of structures may be employed. FIG. 2 illustrates the structure of a general valve 3 which is preferably used as the ball valves 3A to 3C. The ball 5 pivots on a stem 7 in directions indicated by an arrow P. The outer surface of the ball 5 slides on a sheet 8 supported by the inner surface of the body 4. The through-hole preferably has an inner diameter approximately the same as those of the pipes 1 and 10.

In FIG. 2, the through-hole 6 of the ball 5 faces in the axial direction L of the ball valve 3 and is in a fully open state. In FIG. 1, the apparatus for fluid mixing is in normal operation in which the valves are not opened and closed in order to remove an impurity. In the normal operation of the apparatus for fluid mixing, the ball 5 of each of the ball valves 3A to 3C is in a half-open state.

In the normal operation of the apparatus for fluid mixing, the ball valves 3A to 3C are opened to a degree that is preferably in the range from 50 to 95% relative to a fully open state, and more preferably in the range from 60 to 80%. The difference in pressure between one of the valves 3A to 3C and the other valves is preferably in the range from 0.1 to 12.5 kPa, and more preferably in the range from 0.4 to 4 kPa. In general, since use of a ball valve in a half-open state causes the ball of the ball valve to be abraded, the ball valve is not suitable for use in a half-open state. This is because the abrasion of the ball may cause leakage when a valve is closed. In embodiments of the invention, however, the valve does not need to be closed to completely interrupt a flow inside the pipe, and the performance of the apparatus for fluid mixing is not therefore decreased even if some abrasion is caused.

In this embodiment, although a short straight pipe 10 is disposed between each of the ball valves 3A to 3C and the adjacent ball valve to connect the ball valves, the ball valves 3A to 3C may be directly connected to each other without the pipe 10. In place of the straight pipe 10, an L-shaped orthogonal pipe or obliquely bent dogleg pipe may be used. Furthermore, the pipe 10 may be a T-shaped member with a branched structure, and an instrument may be provided to the pipe 10.

A distance a between the junction of fluids and the first valve 3A and distances b between the linearly arranged valves 3A and 3B and between the valves 3B and 3C are preferably as small as possible. In particular, the distances a and b are preferably within ten times as large as the pipe diameter d, more preferably within five times, especially preferably within three times.

Although the stem of each of the ball valves 3A to 3C is illustrated so as to have the axis in a direction normal to the page of FIG. 1, the stem 7 of one of the ball valves 3A to 3C is not preferably in parallel with that of the adjacent ball valve in embodiments of the invention.

In particular, in the case where the axial direction of the stem of the first ball valve 3A is in the 12 o'clock direction with respect to the axial direction L of the ball valve as illustrated in FIG. 2, the axial direction of the stem of the second ball valve 3B is preferably tilted at an angle θ with respect to the 12 o'clock direction. The angular difference θ (positional difference around the axis) is preferably in the range from 15° to 165°, and more preferably in the range from 30° to 150°. The angular difference between the second and third valves or between the subsequent valves is preferably similarly defined.

In the case where only two ball valves are provided, the angular difference θ is preferably approximately in the range from 60° to 120°, an angle of approximately 90° is the most preferable, and an angle of approximately 60° is the second most preferable. In the case where three ball valves are provided, the angular difference θ between the adjacent ball valves is preferably approximately in the range from 60° to 120°, an angle of approximately 90° is the most preferable, and an angle of approximately 60° or 120° is the second most preferable.

### SECOND EMBODIMENT

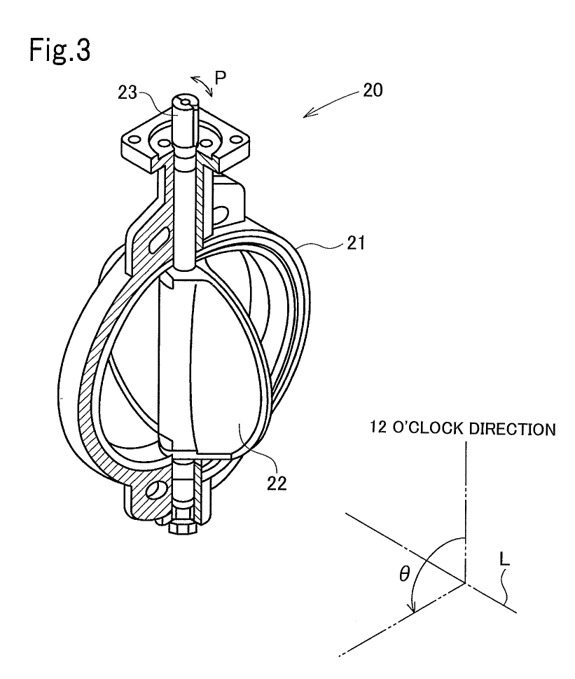

Although the ball valves 3A to 3C are used in the embodiment illustrated in FIG. 1, a butterfly valve 20 illustrated in FIG. 3 may be used.

In the butterfly valve 20 illustrated in FIG. 3, a circular disc (valve disc) 22 is pivotally disposed in an annular body 21 so as to be able to pivot on a stem 23 in directions indicated by an arrow P. The butterfly valve 20 is opened to a degree that is preferably in the range from 30 to 85% relative to a fully open state, especially preferably in the range from 40 to 70%. The difference in pressure between one valve and the adjacent valve is preferably in the range from 0.1 to 12.5 kPa, and more preferably in the range from 0.4 to 4 kPa. The body 21 has an inner diameter approximately the same as those of the pipes 1 and 10.

As in the case of the ball valves 3A to 3C, the butterfly valve is preferably disposed with the angular difference θ with respect to the adjacent butterfly valve. The same angular difference θ as employed in the ball valves 3A to 3C is also preferably employed in this case.

The apparatuses for fluid mixing of the above embodiments can serve to efficiently mix fluids and a fluid with powder or the like.

By virtue of a method using the apparatus, use of a static mixer having a complicated structure is eliminated, and mixing can be sufficiently performed. Furthermore, in the case where an impurity become lodged and causes a pipe to be clogged, the opening degree of the valve is changed to release the impurity. For example, after a half-open valve is fully opened or closed, an operation to return the valve to the half-open state or an operation to change the opening degree of the half-open valve is conducted at least once, preferably several times, thereby being able to release an adhering impurity. An increase in the number of times the valve is opened and closed can further enhance the effect of removing an impurity. However, in the case of increasing the number of times the valve is opened and closed, for example, a hand-operated valve imposes a load on an operator, or an electrically operated valve forces power consumption to be increased. In view of both cases, an operation to reciprocably open and close the valve (an operation having one cycle in which the half-open valve is fully opened or closed and is then returned to a half-open state) is most efficiently conducted three to five times in general.

In the operation to open and close the valve in order to remove an impurity which has become lodged in the valve, the valve is preferably opened and closed in a broad range in both of the opening and closing directions as much as possible. In the case where the apparatus for fluid mixing has a structure in which the valve can be temporarily completely closed, the valve is opened and closed in the range from a fully open state to a fully closed state during the operation to open and close the valve.

In this embodiment, since the pipes 1 and 2 mix fluids or a fluid with powder, an additional vessel is not needed.

### THIRD EMBODIMENT

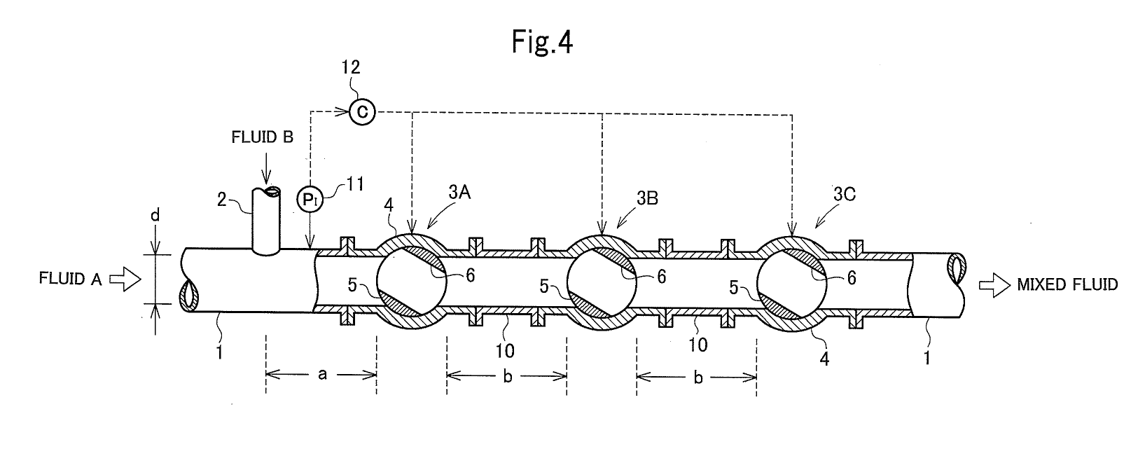

A third embodiment will be hereinafter described with reference to FIG. 4.

In this embodiment, a pressure gauge 11 which has the function of detecting a pressure inside the pipe 1 is provided to the pipe 1 downstream of the branch pipe 2 so as to be positioned anterior to the front-side valve 3A (namely, at a position immediately anterior to the valve 3A). Furthermore, in this embodiment, a valve controller 12 is provided and serves to control the valves 3A to 3C on the basis of a value measured by the pressure gauge 11. The valves 3A to 3C are configured so as to be opened and closed in response to operation signals output from the valve controller 12. Preferable examples of the valves 3A to 3C which are opened and closed in response to the operation signals output from the valve controller 12 include an electrically operated butterfly valve, electrically operated ball valve, and electrically operated gate valve, and various types of commercially available products can be used.

After the apparatus for fluid mixing starts to operate, the pressure gauge 11 measures the pressure inside the pipe 1 in a continuous or constant manner. In the case of constant measurement by the pressure gauge 11, the measurement is preferably performed every 1 to 96 hours, especially every 8 to 48 hours. In the normal operation in which the valve is not opened and closed in order to release an impurity, the valve controller 12 functions to let the valves 3A to 3C in a half-open state open to a certain opening degree. In this case, the valves 3A to 3C are preferably opened in normal operation to a degree that is in the range described above. After the apparatus for fluid mixing starts to operate, the valve controller 12 memorizes the value measured by the pressure gauge 11 at the time the inside of the pipe 1 enters a steady state (hereinafter referred to as an initial pressure value) and calculates the difference between a value subsequently measured by the pressure gauge 11 and the initial pressure value. In the case where the pressure inside the pipe 1 increases from the initial pressure value and reaches a certain level, the valve controller 12 determines that an impurity has become lodged in at least one of the valves 3A to 3C, and the valves 3A to 3C are opened and closed. In this case, a pressure value 110% larger than or equal to the initial pressure value, especially a pressure value 120% larger than or equal to the initial pressure value, is preferably defined as a set pressure value. In the case where the value measured by the pressure gauge 11 reaches a level larger than or equal to the set pressure value or reaches a level larger than or equal to a set pressure value which has been defined as 30 kPa or higher, a pressure controller 12 determines that an impurity has become lodged in at least one of the valves 3A to 3C with the result that the valves 3A to 3C are opened and closed. The valve controller 12 is configured so as to function, for example, as follows: the half open valves 3A to 3C are fully opened or closed for a certain time period (preferably one to five seconds, more preferably two to three seconds), and then the valves 3A to 3C are returned to the half-open state or the opening degree of the valves 3A to 3C in the half open state is changed; and this cycle is repeated a certain number of times (preferably several times, more preferably three to five times as described above). The initial pressure value may be preliminarily defined on the basis of an experimental rule or the like. Alternatively, the upper limit of the pressure inside the pipe 1 is preliminarily defined, and the valve controller 12 may be configured so as to open and close the valves 3A to 3C in the case where the value measured by the pressure gauge 11 exceeds the set value.

In the case where a pressure-changing factor which causes the pressure change inside the pipe 1 is positioned downstream of the valve 3C which is the furthermost valve of the apparatus for fluid mixing, the cycle of the pressure change which is caused by the pressure-changing factor inside the pipe 1 is analyzed, and the occurrence of clogging of the pipe 1 due to an impurity is determined under certain conditions. Examples of the pressure-changing factor positioned downstream of the valve 3C include a pressure sand filter. In the case where such a filter is provided downstream of the valve 3C, the clogging of the pipe 1 due to an impurity is preferably analyzed immediately after reverse cleaning of the filter.

The other configurations of this embodiment are the same as those of the embodiment illustrated in FIG. 1, and the same reference signs as used in FIG. 1 refer to the same elements in FIG. 4.

In the apparatus for fluid mixing with such a configuration, in the case where a pressure inside the pipe 1 immediately anterior to the valve 3A increases from the initial pressure and then reaches a certain level, the pressure controller 12 determines that an impurity has become lodged in at least one of the valves 3A to 3C, and the valves 3A to 3C are opened and closed, thereby releasing the impurity. By virtue of such an operation, the following problems can be prevented: waste of energy due to the operation of the apparatus for fluid mixing in a state in which an impurity lodges inside the pipe 1 and then increases the pressure inside the pipe 1; and a decreased flow rate caused by the clogging of the pipe 1. Furthermore, unnecessary changing of the opening degree of the valves 3A to 3C can be prevented in the case where an impurity has not become lodged in the valves 3A to 3C, and the apparatus for fluid mixing can be efficiently operated.

Although this embodiment has a mechanism in which the valve controller 12 automatically opens and closes the valves 3A to 3C in response to the value measured by the pressure gauge 11, the following configuration may be employed: an operator constantly checks the value measured by the pressure gauge 11; in the case where the value indicated by the pressure gauge 11 increases from the value exhibited at the time of the start of operation (or a set value defined in advance) and then reaches a certain level, the operator determines that an impurity has become lodged in at least one of the valves 3A to 3C; and the operator manually opens and closes the valves 3A to 3C or manipulates the valve controller to open and close the valves 3A to 3C. In this case, if an analog type pressure gauge is used as the pressure gauge 11, the pressure gauge 11 is configured so as to have a display on which the initial pressure value is marked, thereby enabling an increase in pressure inside the pipe 1 from the initial pressure value to be easily checked.

### FOURTH EMBODIMENT

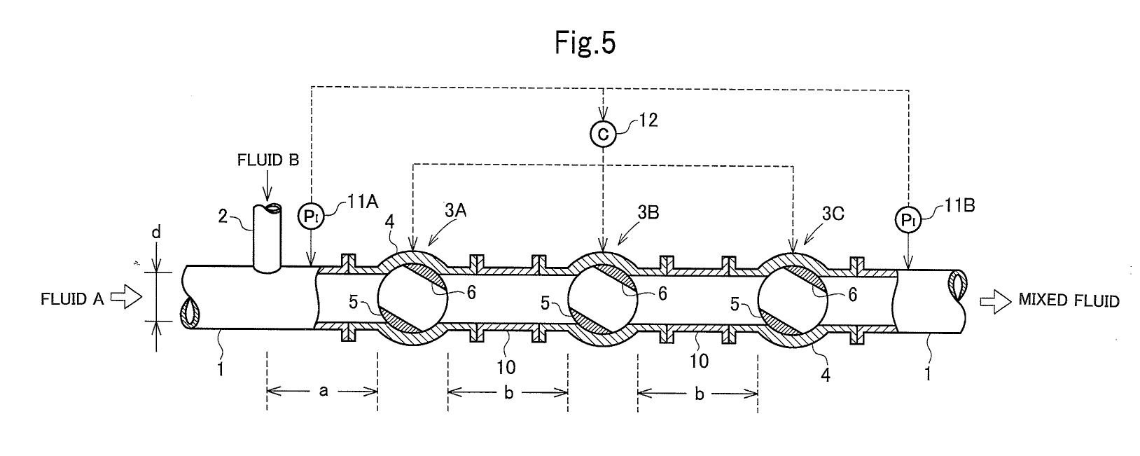

A fourth embodiment will be hereinafter described with reference to FIG. 5.

In this embodiment, a pressure gauge 11A which has the function of detecting a pressure inside the pipe 1 is provided to the pipe 1 downstream of the branch pipe 2 so as to be positioned anterior to the front-side valve 3A (namely, at a position immediately anterior to the valve 3A), and a pressure gauge 11B which has the function of detecting a pressure inside the pipe 1 is provided to the pipe 1 downstream of the furthermost valve 3C (namely, at a position immediately posterior to the valve 3C). In other words, the pressure gauges 11A and 11B of this embodiment form a pressure loss detector which detects pressure loss between the upstream and downstream sides relative to the group of the valves 3A to 3C. The pressure gauges 11A and 11B operate in conjunction with each other and measure the pressure inside the pipe 1 in a continuous or constant manner. In the case of constant measurement by the pressure gauges 11A and 11B, the measurement is preferably performed every 1 to 96 hours, especially every 8 to 48 hours. In this example, the pressure gauge 11 of the apparatus for fluid mixing illustrated in FIG. 4 is also employed as each of the pressure gauges 11A and 11B.

In this embodiment, the valve controller 12 functions to calculate the difference between values measured by the pressure gauges 11A and 11B, namely, the difference in pressure loss between the upstream and downstream sides relative to the group of the valves 3A to 3C, and then control the valves 3A to 3C on the basis of the pressure loss. In particular, in this embodiment, after the apparatus for fluid mixing starts to operate, the valve controller 12 memorizes a pressure loss obtained from values measured by the pressure gauges 11A and 11B at the time the inside of the pipe 1 enters a steady state (hereinafter referred to as an initial pressure loss) and calculates the difference between a pressure loss obtained from values subsequently measured by the pressure gauges 11A and 11B and the initial pressure loss. In the case where the pressure loss inside the pipe 1 increases from the initial pressure loss and reaches a certain level, the valve controller 12 determines that an impurity has become lodged in at least one of the valves 3A to 3C, and the valves 3A to 3C are opened and closed. In this case, a pressure loss 150% larger than the initial pressure loss, especially a pressure loss 200% larger than the initial pressure loss, is preferably defined as a set pressure value. In the case where the pressure loss obtained from the values measured by the pressure gauges 11A and 11B reaches a level larger than or equal to the set pressure loss or reaches a level larger than or equal to a set pressure loss which has been defined as 5 kPa or higher, a pressure controller 12 determines that an impurity has become lodged in at least one of the valves 3A to 3C with the result that the valves 3A to 3C are preferably opened and closed. The valves 3A to 3C are opened and closed in the same manner as employed in the apparatus for fluid mixing illustrated in FIG. 4. The initial pressure loss may be preliminarily defined on the basis of an experimental rule or the like. Alternatively, the upper limit of the pressure loss is preliminarily defined on the basis of an experimental rule or the like, and the valve controller 12 may be configured so as to open and close the valves 3A to 3C in the case where the pressure loss obtained from the values measured by the pressure gauges 11A and 11B exceeds the set value. Also in this embodiment, in the normal operation in which the valve is not opened and closed in order to release an impurity, the valve controller 12 functions to let the valves 3A to 3C in the half-open state open to a certain opening degree.

The other configurations of this embodiment are the same as those illustrated in FIG. 1, and the same reference signs as used in FIG. 1 refer to the same elements in FIG. 4.

In the apparatus for fluid mixing with such a configuration, the pressure loss between the upstream and downstream sides relative to the group of the valves 3A to 3C increases from the initial pressure loss and then reaches a certain level, the valve controller 12 determines that an impurity has become lodged in at least one of the valves 3A to 3C, and the valves 3A to 3C are opened and closed, thereby releasing the impurity. By virtue of such an operation, the following problems can be prevented: waste of energy due to the operation of the apparatus for fluid mixing in a state in which an impurity has become lodged inside the pipe 1 and then increases pressure inside the pipe 1; and a decreased flow rate caused by clogging of the pipe 1. Furthermore, unnecessary changing of the opening degree of the valves 3A to 3C can be prevented in the case where an impurity has not become lodged in the valves 3A to 3C, and the apparatus for fluid mixing can be efficiently operated.

Although this embodiment has a mechanism in which the valve controller 12 automatically opens and closes the valves 3A to 3C in response to the pressure loss obtained from the values measured by the pressure gauges 11A and 11B, the following configuration may be employed: an operator constantly checks the values measured by the pressure gauges 11A and 11B and then calculates the pressure loss; in the case where the pressure loss increases from the pressure loss at the time of the start of operation (or a set value defined in advance) and then reaches a certain level, the operator manually opens and closes the valves 3A to 3C or manipulates the valve controller to open and close the valves 3A to 3C.

In this embodiment, the first pressure gauge 11A is provided to the pipe 1 at a position immediately anterior to the valve 3A, and the second pressure gauge 11B is provided to the pipe 1 at a position immediately posterior to the valve 3C. Although the difference between the values measured by the pressure gauges 11A and 11B is defined as the pressure loss between the upstream and downstream sides relative to the group of the valves 3A to 3C, the technique for measuring the pressure loss between the upstream and downstream sides relative to the group of the valves 3A to 3C is not limited to the technique of this embodiment. For instance, a differential pressure gauge may be provided to the apparatus for fluid mixing so as to cover the group of the valves 3A to 3C as a measurement region. In the case where an air-releasing portion is provided to the pipe 1 downstream of the valve 3C, a pressure exhibited posterior to the valve 3C is defined as atmospheric pressure, and the value measured by the pressure gauge 11A provided to the pipe 1 upstream of the valve 3A can be defined as the pressure loss between the upstream and downstream sides relative to the group of the valves 3A to 3C. Alternatively, the pressure loss inside the pipe 1 between a position immediately posterior to the valve 3C and the air-releasing portion is compensated for, and the value measured by the pressure gauge 11A provided to the pipe 1 upstream of the valve 3A can be defined as the pressure loss between the upstream and downstream sides relative to the group of the valves 3A to 3C.

In the case of using the apparatus of embodiments of the invention for addition of a coagulant, an inorganic coagulant and a pH adjuster are individually put into a pipe in which wastewater containing SS flows and then pass half-water open valves with the result that the additives can be efficiently mixed.

### EXAMPLES

Although embodiments of the invention will be described further in detail with reference to examples, embodiments of the invention are not limited to the examples within the scope of the invention.

### Example 1

The apparatus for fluid mixing illustrated in FIG. 4 was used to perform coagulation treatment of industrial organic wastewater under the following conditions.
Fluid A: industrial organic wastewater (flow rate: 10 m³/h)
Fluid B: aqueous solution of 10% polyaluminum chloride (as Al₂O₃) (additive amount: 300 mg/L)
Valves 3A to 3C: ball valve
Inner diameter of through-hole 6 and inner diameters of pipes 1 and 10: 75 mm
Opening degree of valves 3A to 3C in normal operation: 70%
Angular difference θ between valves 3A and 3B: 90°
Angular difference θ between valves 3B and 3C: 90°
After the start of the operation, all of the valves 3A to 3C were fully opened at the time the value measured by the pressure gauge 11 reached a level larger than or equal to 50 kPa, and the opening degree was returned to the initial level in two seconds. Then, all of the valves 3A to 3C were opened every time the value measured by the pressure gauge 11 reached a level larger than or equal to 50 kPa, and the opening degree was returned to the initial level in two seconds.

During a flow examination of 30 days, the flow rate of a fluid which had passed the apparatus for fluid mixing did not fall below 90% of the flow rate measured at the start of the operation, and the coagulation treatment was efficiently performed.

### Example 2

The apparatus for fluid mixing illustrated in FIG. 5 was used, and coagulation treatment of industrial organic wastewater was performed under the following conditions as in the case of Example 1.

The pressure gauges 11A and 11B were used to measure a pressure loss through the valves 3A to 3C. Except for these changes, the coagulation treatment was performed under the same conditions as employed in Example 1.

Immediately after the start of the operation, a difference between a value measured by the pressure gauge 11A and a value measured by the pressure gauge 11B (initial pressure loss) was 4 kPa. Then, all of the valves 3A to 3C were opened at the time the measured value of a pressure loss reached a level larger than or equal to 10 kPa, and the opening degree was returned to the initial level in two seconds. All of the valves 3A to 3C were subsequently opened every time the measured value of the pressure loss reached a level larger than or equal to 10 kPa, and the opening degree was returned to the initial level in two seconds.

During a flow examination of 30 days, the flow rate of a fluid which had passed the apparatus for fluid mixing did not fall below 90% of the flow rate measured at the start of the operation, and the coagulation treatment was efficiently performed.

### Reference Example

The apparatus for fluid mixing illustrated in FIG. 1 was used, and the valves 3A to 3C were not opened and closed at all. Except for these changes, the coagulation treatment of industrial organic wastewater was performed under the same conditions as employed in Example 1.

During a flow examination of 30 days, the coagulation treatment was successfully performed. After the passage of 30 days, however, the flow rate decreased by approximately 30% relative to the flow rate measured at the start of the operation.

The valve 3A was checked after the operation was stopped, and it was observed that the valve 3A was clogged with an impurity.

Although embodiments of the invention have been described in detail with reference to specific embodiments, it is obvious to those skilled in the art that embodiments of the invention can be variously modified without departing from the spirit and scope of the invention.

The present invention contains subject matter related to Japanese Patent Application (Japanese Patent Application No. 2009-217305) filed in the Japanese Patent Office on Sep. 18, 2009 and Japanese Patent Application (Japanese Patent Application No. 2010-080891) filed in the Japanese Patent Office on Mar. 31, 2010, the entire contents of which are incorporated herein by reference.

1. An apparatus for fluid mixing comprising:
a pipe in which a first fluid flows;
a junction through which any one of a second fluid and powder flows into the pipe; and
an openable and closable valve provided to a pipe downstream of the junction,
said valve being in a half-open state.

2. The apparatus for fluid mixing according to claim 1, further comprising a pressure detector which detects a pressure inside the pipe upstream of the valve.

3. The apparatus for fluid mixing according to claim 1, further comprising a pressure loss detector which detects a pressure loss inside the pipe between the upstream and downstream sides relative to the valve.

4. The apparatus for fluid mixing according to claim 1, wherein any one of a ball valve and butterfly valve is employed as the valve.

5. The apparatus for fluid mixing according to claim 4, wherein the ball valve opens to a degree that is in the range from 50 to 95% relative to a fully open state.

6. The apparatus for fluid mixing according to claim 4, wherein the butterfly valve opens to a degree that is in the range from 30 to 85% relative to a fully open state.

7. The apparatus for fluid mixing according to claim 4, wherein a plurality of the valves are provided in line, and the position around the axis of one valve differs from the position around the axis of the adjacent valve.

8. The apparatus for fluid mixing according to claim 7, wherein three to four valves are provided.

9. A method for fluid mixing, the method comprising mixing a fluid by using the apparatus for fluid mixing of claim 1.

10. The method for fluid mixing according to claim 9, wherein the opening degree of the valve is changed in the case where an impurity becomes lodged in the valve, and the impurity is then released.

11. The method for fluid mixing according to claim 10, wherein the apparatus for fluid mixing of claim 2 is used, wherein
a pressure inside the pipe is measured with the pressure detector in any one of the continuous and constant manners, and the opening degree of the valve is changed in the case where the pressure increases and then reaches a certain level.

12. The method for fluid mixing according to claim 10, wherein the apparatus for fluid mixing of claim 3 is used, wherein
a pressure loss inside the pipe is measured with the pressure loss detector in any one of the continuous and constant manners, and the opening degree of the valve is changed in the case where the pressure loss increases and then reaches a certain level.

13. The method for fluid mixing according to claim 9, wherein fluids are mixed with each other.

14. The method for fluid mixing according to claim 13, wherein wastewater is mixed with a coagulant solution.
